(19) United States
(12) Patent Application Publication
(10) Pub. No.: US 2013/0241471 A1
(43) Pub. Date: Sep. 19, 2013

(54) CHARGE CONTROL CIRCUIT AND BATTERY DEVICE

(71) Applicants: Kuniaki ARAI, Tokyo (JP); Masashi Oshima, Yokohama-shi (JP); Daisuke Kanzaki, Yokohama-shi (JP)

(72) Inventors: Kuniaki ARAI, Tokyo (JP); Masashi Oshima, Yokohama-shi (JP); Daisuke Kanzaki, Yokohama-shi (JP)

(73) Assignee: RICOH COMPANY, LTD., Tokyo (JP)

(21) Appl. No.: 13/795,003

(22) Filed: Mar. 12, 2013

(30) Foreign Application Priority Data
Mar. 14, 2012 (JP) 2012-057685

(51) Int. Cl. H02J 7/00

(52) U.S. Cl. CPC H02J 7/007
USPC 320/107

(57) ABSTRACT

A charge control circuit for controlling charging of a plurality of batteries includes switching elements respectively connected in parallel to the batteries, and a charge control device for reducing charging current to the respective batteries. The charge control device converts voltages of the respective batteries into multiple converted battery voltages based on a predetermined reference voltage as a reference on the basis of voltages at both ends of the respective batteries, generates an offset battery voltage obtained by adding a predetermined offset voltage to the converted battery voltages, compares each converted battery voltage with the offset battery voltage, and reduces charging current to the corresponding battery by turning on the switching element connected in parallel to the corresponding battery when the each converted battery voltage is higher than the offset voltage.

### CROSS-REFERENCE TO RELATED APPLICATION

The present application claims priority to Japanese Patent Application No. 2012-057685 filed Mar. 14, 2012 to the Japan Patent Office, the entire content of which is incorporated herein by reference in its entirety.

### BACKGROUND OF THE INVENTION

1. Field of the Invention

The present invention relates to a charge control circuit for controlling charging to a battery circuit including a plurality of battery cells (hereinafter referred to as cells) connected in series and a battery device including the charge control circuit.

2. Description of the Related Art

In a protection IC for a multi-cell Li ion secondary battery, cell voltages of a plurality of cells easily become unbalanced, and a function to balance the plurality of cell voltages is required. In general, a balancing method that turns on a transistor connected to cells in parallel when each cell voltage becomes equal to or higher than a certain voltage has already been in place.

In addition, in Japanese Patent Application Publication No. 2009-254008, for example, in order to provide a charge/discharge control circuit and a battery device which can better prevent shortage in charging of a battery, detection of a cell balance (CB) period is performed before charging of each battery is stopped, i.e., after controlling of CB, and charging of each battery is stopped, even if overcharge detection voltage of a certain charge/discharge control circuit falls below a CB period detection voltage due to variations in manufacturing during mass production of charge/discharge control circuits. This has the operation and effect that can better prevent shortage in charging of each battery.

FIG. 1 is a circuit diagram showing a configuration of a charge control circuit of a conventional technique and a peripheral circuit thereof. In FIG. 1, the circuit is configured to include a protection IC circuit 100 including cells C1 to C5 connected to each other in series, resistors R101 to R105 for a bypass current, MOS transistors M101 to M105 for reducing charging current, and comparators COMP101 to COMP 105.

In FIG. 1, a charger 200 charges the cell C1, the cell C2, the cell C3, the cell C4, and the cell C5 at 110 mA, for example. Here, it is assumed that a turnover voltage of the comparator COMP101, the comparator COMP102, the comparator COMP103, the comparator COMP104, and the comparator COMP105 is 4.15V. For example, when a voltage of the cell C1 increases and exceeds 4.15V, the comparator COMP101 is turned over and voltage CB1 goes to high level. This turns on the MOS transistor M101, and current of 4.15V/40Ω=104 mA runs through the resistor R101. Then, current running through the cell C1 is 110 mA−104 mA=6 mA. With this, charging current to the cell C1 can be reduced.

For the cell C2, in FIG. 1, since the cell voltage is 4.2V, the comparator COMP102 is turned over and voltage CB2 goes to high level. This turns on the MOS transistor M102, and current of 4.2V/40Ω=105 mA runs through the resistor R102. Then, current running through the cell C2 is 110 mA−105 mA=5 mA. With this, charging current to the cell C2 can be reduced.

For the cell C3, the cell C4, and the cell C5, in FIG. 1, since the cell voltage is 3.8V, the comparator COMP103, the comparator COMP104, and the comparator COMP105 are not turned over, and voltages CB3, CB4, and CB5 are at low level. With this, the MOS transistors M103, M104, and M105 are not turned on, charging current of 110 mA runs through the cell C3, the cell C4, and the cell C5, and the charging current can be supplied to the cell C3, the cell C4, and the cell C5, rather than the cell C1 and the cell C2. With the above, for any cell which exceeds the turnover voltage (i.e., balance voltage of cell voltage) of the comparator COMP101, the comparator COMP102, the comparator COMP103, the comparator COMP104, and the comparator COMP105, the charging current can be reduced and cell voltage increasing speed due to charging can be lowered. Consequently, charging can be performed and completed while a reduced voltage difference with cells which do not exceed the turnover voltage (i.e., balance voltage of cell voltage) of the comparator COMP101, the comparator COMP102, the comparator COMP103, the comparator COMP104, and the comparator COMP105.

However, the cell voltage balancing method of the conventional technique has a problem that batteries are charged without balancing a cell voltage when the cell voltage is low. Specifically, there is a problem as follows: batteries are charged with the cell voltage unbalanced, and a transistor connected in parallel to cells turns on to attempt to balance the cell voltage when a battery voltage exceeds a certain voltage. However, when the cell voltage is low, the cell voltage is unbalance, and thus cannot be balanced. When one cell voltage exceeds an overcharge detection voltage, charging is disabled and completed with the battery voltage remaining unbalanced.

In addition, the charge control device disclosed in Japanese Patent Application Publication No. 2009-254008 has the balancing method of the conventional technique described above, wherein a relation of balance voltage of cell voltage and overcharge detection voltage is normally as follows: the balance voltage of cell voltage <overcharge detection voltage. However, control of the charge control circuit is such that balancing of the cell voltage takes precedence even when the relation of the balance voltage of cell voltage and the overcharge detection voltage is reversed due to variations between chips. While this makes it easier to balance the cell voltage, it cannot entirely overcome the problem described above.

### SUMMARY OF THE INVENTION

An object of the present invention is to solve the problem described above and to provide a charge control circuit capable of balancing cell voltages without relying on the cell voltages and charging a battery till voltages of all cells are close to a full charge state, and a battery device provided therewith.

To accomplish the above-described object, a charge control circuit according to an embodiment of the present invention is a charge control circuit for controlling charging of a plurality of batteries included in a battery circuit and connected in series when the battery circuit is charged by a charger at both ends of the battery circuit, the charge control circuit including: a plurality of switching elements respectively connected in parallel to the plurality of batteries; and a charge control device for reducing charging current to the respective batteries.

The charge control device includes one of:

(A) a first control device which converts voltages of the respective batteries into a plurality of converted battery voltages based on a predetermined reference voltage as a reference on the basis of voltages at both ends of the respective batteries, generates an offset battery voltage obtained by adding a predetermined offset voltage to the plurality of converted battery voltages, compares each of the plurality of converted battery voltages with the offset battery voltage, and reduces charging current to the corresponding battery by turning on the switching element connected in parallel to the corresponding battery when the each converted battery voltage is higher than the offset voltage;
(B) a second control device which converts voltages of the respective batteries into a plurality of converted battery voltages based on a predetermined reference voltage as a reference on the basis of voltages at both ends of the respective batteries, generates a battery mean voltage of the respective battery voltages which is a mean voltage of the respective voltages based on the predetermined reference voltage as a reference, compares each of the plurality of converted battery voltages with the battery mean voltage, and reduces charging current to the corresponding battery by turning on the switching element connected in parallel to the corresponding battery when the each converted battery voltage is higher than the battery mean voltage; and
(C) a third control device which generates a pair of offset battery voltages obtained by adding and subtracting a predetermined offset voltage to/from a mean voltage of a pair of mutually adjacent batteries of the plurality of batteries on the basis of voltages at both ends of the respective batteries, compares the pair of offset battery voltages with the voltage of one battery of the pair of mutually adjacent batteries to thereby determine a battery with a higher battery voltage of the pair of batteries when the pair of offset battery voltages are higher than the voltage of the one battery of the pair of mutually adjacent batteries, and reduces charging current to the corresponding battery by turning on the switching element connected in parallel to the battery whose battery voltage is determined to be higher.

A battery device according to another embodiment of the present invention includes: a battery circuit including a plurality of batteries connected in series; and the charge control circuit described above.

### BRIEF DESCRIPTION OF THE DRAWINGS

FIG. 1 is a circuit diagram showing a configuration of a charge control circuit of a conventional technique and a peripheral circuit thereof.

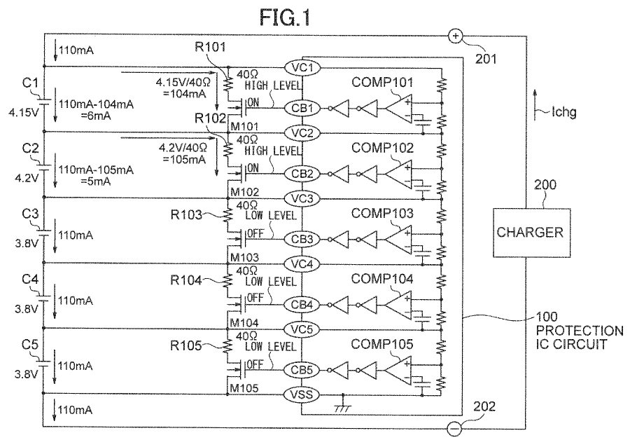

FIG. 2 is a circuit diagram showing a configuration of a charge control circuit according to a first embodiment and a peripheral circuit thereof.

FIG. 3 is a circuit diagram showing a configuration of a logic circuit 30 of FIG. 2.

FIG. 4 is a circuit diagram showing a configuration of a charge control circuit according to a second embodiment and a peripheral circuit thereof.

FIG. 5 is a circuit diagram showing a configuration of a logic circuit 31 of FIG. 4.

FIG. 6 is a circuit diagram showing a configuration of a charge control circuit according to a modification of the second embodiment and a peripheral circuit thereof.

FIG. 7 is a circuit diagram showing a configuration of a charge control circuit according to a third embodiment and a peripheral circuit thereof.

FIG. 8 is a circuit diagram showing configuration of a logic circuit 32 of FIG. 7.

FIG. 9 is a circuit diagram showing a configuration of a charge control circuit according to a modification of the third embodiment and a peripheral circuit thereof.

FIG. 10 is a circuit diagram showing configurations of logic circuits 32-1, 32-2 of FIG. 9.

### DESCRIPTION OF THE PREFERRED EMBODIMENTS

In the following, embodiments according to the present invention will be described with reference to the drawings. Note that same symbols are assigned to similar components throughout the following embodiments.

### First Embodiment

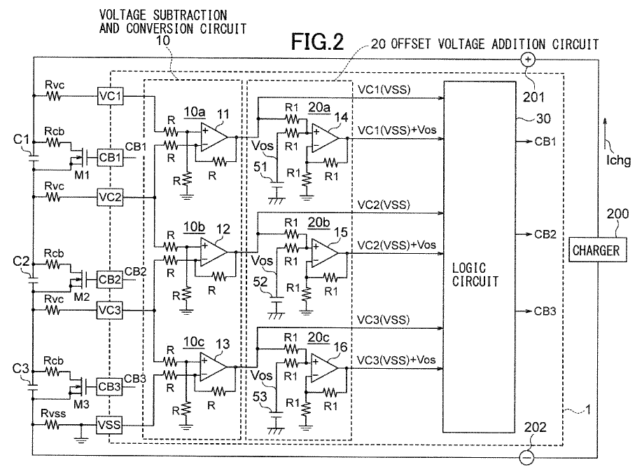

FIG. 2 is a circuit diagram showing a configuration of a charge control circuit according to a first embodiment and a peripheral circuit thereof. In FIG. 2, charging current Ichg is supplied from a charger 200 to a battery circuit of three cells C1, C2, C3, which are secondary batteries connected in series to each other, via charging terminals 202, 201, Here, a protection IC circuit 1 for charge control is connected to the battery circuit. The protection IC circuit 1 is configured to include a voltage subtraction and conversion circuit 10, an offset voltage addition circuit 20, and a logic circuit 30. In addition, for each of the cells C1 to C3, a protection resistor Rvc or Rvss, a bypass current resistor Rcb, and a MOS transistor (switching element) M1, M2, or M3 connected thereto for reducing charging current are connected between the battery circuit and the protection IC circuit 1. In one example of the embodiment, when a maximum voltage of each of the cells C1 to C3=4.3V and the charging current Ichg=2 mA, Rcb=100Ω and Rvss=Rvc=0Ω, for example. Note that a voltage of the cell C1 is expressed by VC1, a voltage of the cell C2 is expressed by VC2, and a voltage of the cell C3 is expressed by VC3. Also note that gate voltages (cell balance period voltages) to be applied to the gates of the respective MOS transistors M1, M2, and M3 are represented by CB1, CB2, and CB3, respectively.

The voltage subtraction and conversion circuit 10 is configured to include:

(a) a voltage subtraction and conversion unit 10a configured to include four resistors R and an operational amplifier 11, computing a difference between two voltages to be inputted, converting it into a converted battery voltage with a ground potential VSS as a reference, and then outputting it;
(b) a voltage subtraction and conversion unit 10b configured to include four resistors R and an operational amplifier 12, computing a difference between two voltages to be inputted, converting it into a converted battery voltage with the ground potential VSS as a reference, and then outputting it; and
(c) a voltage subtraction and conversion unit 10c configured to include four resistors R and an operational amplifier 13, computing a difference between two voltages to be inputted, converting it into a converted battery voltage with the ground potential VSS as a reference, and then outputting it.

In the voltage subtraction and conversion circuit 10, the voltage subtraction and conversion unit 10a computes voltages VC1−VC2, and converts the voltage VC1 of the cell C1 into the converted battery voltage VC1 (VSS standard) of the ground potential VSS standard (hereinafter expressed as VC1(VSS), which also applies to other voltages. Specifically, (VSS) expresses the voltage of the ground potential VSS standard), and outputs it. The voltage subtraction and conversion unit 10b computes voltages VC2−VC3, converts the voltage VC2 of the cell C2 into the converted battery voltage VC2(VSS) of the ground potential VSS standard, and outputs it. The voltage subtraction and conversion unit 10c computes voltages VC3−VSS, converts the voltage VC3 of the cell C3 into the converted battery voltage VC3(VSS) of the ground potential VSS standard, and outputs it.

The offset voltage addition circuit 20 is configured to include:

(a) an offset voltage adder 20a configured to include four resistors R1, a voltage source 51 of an offset voltage Vos, and an operational amplifier 14, adding two voltages to be inputted, and generating and outputting an offset battery voltage to which the offset voltage Vos is added;
(b) an offset voltage adder 20b configured to include four resistors R1, a voltage source 52 of the offset voltage Vos, and an operational amplifier 15, adding two voltages to be inputted, and generating and outputting an offset battery voltage to which the offset voltage Yes is added;
(c) an offset voltage adder 20c configured to include four resistors R1, a voltage source 53 of the offset voltage Vos, and an operational amplifier 16, adding two voltages to be inputted, and generating and outputting an offset battery voltage to which the offset voltage Vos is added.

In the offset voltage addition circuit 20, the offset voltage adder 20a generates an offset battery voltage VC1(VSS)+Vos obtained by adding the offset voltage Vos (60 mV, for example) to the voltage VC1(VSS). The offset voltage adder 20b generates an offset battery voltage VC2(VSS)+Vos obtained by adding the offset voltage Vos (60 mV, for example) to the voltage VC2(VSS). The offset voltage adder 20c generates an offset battery voltage VC3(VSS)+Vos obtained by adding the offset voltage Vos (60 mV, for example) to the voltage VC1(VSS).

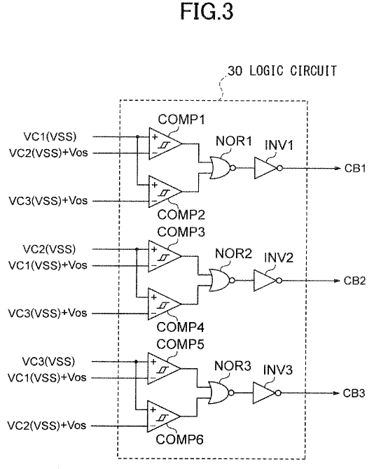

FIG. 3 is a circuit diagram showing configuration of the logic circuit 30 of FIG. 2. In FIG. 3, the logic circuit 30 is configured to include six comparators COMP1 to COMP6, three NOR gates NOR1 to NOR3, and three inverters INV1 to INV3. In FIG. 3, the voltage VC1(VSS), the voltage VC2(VSS), the voltage VC3(VSS), the voltage VC1(VSS)+Vos, the voltage VC2(VSS)+Vos, and the voltage VC3(VSS)+Vos are inputted into the logic circuit 30. Comparing the voltage VC1(VSS) with the voltage VC2(VSS)+Vos, the comparator COMP1 outputs a binary signal, which is a result of the comparison, to the inverter INV1 via the NOR gate NOR1. Comparing the voltage VC1(VSS) with the voltage VC3(VSS)+Vos, the comparator COMP2 outputs a binary signal, which is a result of the comparison, to the inverter INV1 via the NOR gate NOR1. Comparing the voltage VC2(VSS) with the voltage VC1(VSS)+Vos, the comparator COMP3 outputs a binary signal, which is a result of the comparison, to the inverter INV2 via the NOR gate NOR2. Comparing the voltage VC2(VSS) with the voltage VC3(VSS)+Vos, the comparator COMP4 outputs a binary signal, which is a result of the comparison, to the inverter INV2 via the NOR gate NOR2. Comparing the voltage VC3(VSS) with the voltage VC1(VSS)+Vos, the comparator COMP5 outputs a binary signal, which is a result of the comparison, to the inverter INV3 via the NOR gate NOR3. Comparing the voltage VC3(VSS) with the voltage VC2(VSS)+Vos, the comparator COMP6 outputs a binary signal, which is a result of the comparison, to the inverter INV3 via the NOR gate NOR3.

The logic circuit 30 outputs a high-level cell balance period voltage CB1 to a gate of the MOS transistor M1

(a) when the voltage VC1(VSS) is higher than the voltage VC2(VSS)+Vos; or
(b) when the voltage VC1(VSS) is higher than the voltage VC3(VSS)+Vos. This turns on the MOS transistor M1 and bypasses the charging current running through the cell C1. In addition, the logic circuit 30 outputs a high-level cell balance period voltage CB2 to a gate of the MOS transistor M2
(a) when the voltage VC2(VSS) is higher than the voltage VC1(VSS)+Vos; or
(b) when the voltage VC2(VSS) is higher than the voltage VC3(VSS)+Vos. This turns on the MOS transistor M2 and bypasses the charging current running through the cell C2. Furthermore, the logic circuit 30 outputs a high-level cell balance period voltage CB3 to a gate of the MOS transistor M3
(a) when the voltage VC3(VSS) is higher than the voltage VC1(VSS)+Vos; or
(b) when the voltage VC3(VSS) is higher than the voltage VC2(VSS)+Vos. This turns on the MOS transistor M3 and bypasses the charging current running through the cell C3.

With the operations described above, when a potential difference between respective pairs of the cell C1, the cell C2, and the cell C3 exceeds Vos (60 mV, for example), balancing of the respective cell voltages can be achieved by bypassing charging current which runs through the cell of a higher potential of the pair of cells.

In the charge control circuit according to the embodiment, charging is possible while balancing cell voltages among the cell C1, the cell C2, and the cell C3.

### Second Embodiment

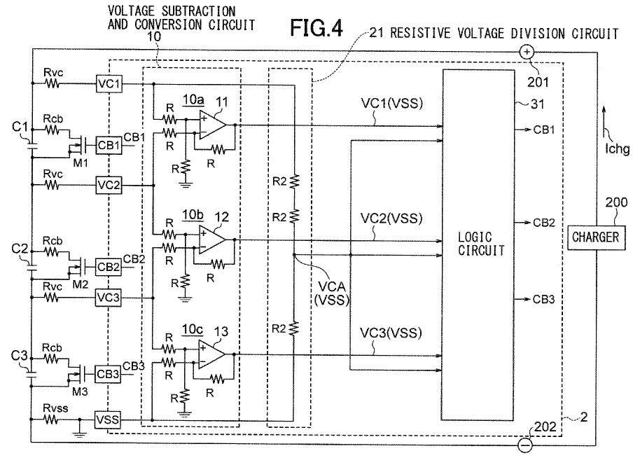

FIG. 4 is a circuit diagram showing a configuration of a charge control circuit according to a second embodiment and a peripheral circuit thereof. In comparison with the charge control circuit according to the first embodiment in FIG. 2, the charge control circuit according to the second embodiment in FIG. 4:

(1) includes a resistive voltage division circuit 21, in place of the offset voltage addition circuit 20; and
(2) includes a logic circuit 31, in place of the logic circuit 30. In the following, the differences will be described.

In FIG. 4, the resistive voltage division circuit 21 is configured by three resistors R2 having an identical resistance value and connected in series. To balance cell voltages for three cells, for example, by resistively dividing voltages (VC1−VSS) between the voltage VC1 and the voltage VSS using the three resistors R2, the circuit generates a cell mean voltage (battery mean voltage) VCA(VSS) of the three cell voltages expressed by the following expression and outputs it to the logic circuit 31.

$$\begin{matrix}[ Expression 1 ] & \\ \begin{matrix}VCA ( VSS ) = ( VC 1 - VSS ) ( 1 R ) / ( 3 R ) \\ = ( VC 1 - VSS ) / 3\end{matrix} & ( 1 )\end{matrix}$$

Note that the voltage VC1(VSS), the voltage VC2(VSS), and the voltage VC3(VSS) from the voltage subtraction and conversion circuit 10 are inputted into the logic circuit 31.

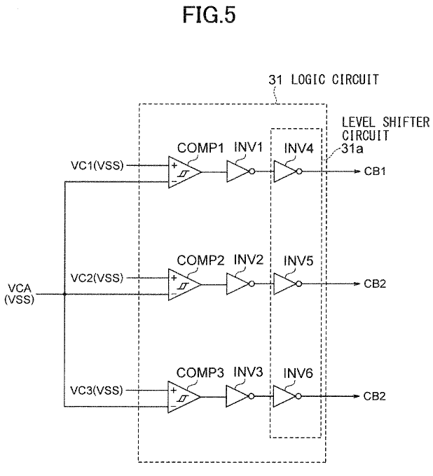

FIG. 5 is a circuit diagram showing a configuration of the logic circuit 31 of FIG. 4. In FIG. 5, the logic circuit 31 is configured to include three comparators COMP1 to COMP3, three inverters INV1 to INV3, and three inverters INV4 to INV6 each of which is inverted to a value of a supply voltage VDD level.

In FIG. 5, comparing the voltage VCA(VSS) with the cell mean voltage VCA(VSS), the comparator COMP1 outputs a binary signal, a result of the comparison, via the inverters INV1, INV4, and the cell balance period voltage CB1, to the gate of the MOS transistor M1. Comparing the voltage VC2(VSS) with the cell mean voltage VCA(VSS), the comparator COMP2 outputs a binary signal, a result of the comparison, via the inverters INV2, INV5, and the cell balance period voltage CB2, to the gate of the MOS transistor M2. Comparing the voltage VC3(VSS) with the cell mean voltage VCA(VSS), the comparator COMP3 outputs a binary signal, a result of the comparison, via the inverters INV3, INV6, and the cell balance period voltage CB3, to the gate of the MOS transistor M3.

When the voltage VC1(VSS) is higher than the cell mean voltage VCA(VSS), the logic circuit 31 generates a high level cell balance period voltage CB1 and outputs it to the gate of the MOS transistor M1 to turn on the MOS transistor M1, and bypasses charging current running through the cell C1. In addition, when the voltage VC2(VSS) is higher than the cell mean voltage VCA(VSS), the logic circuit 31 generates a high level cell balance period voltage CB2 and outputs it to the gate of the MOS transistor M2 to turn on the MOS transistor M2, and bypasses charging current running through the cell C2. In addition, when the voltage VC3(VSS) is higher than the cell mean voltage VCA(VSS), the logic circuit 31 generates a high level cell balance period voltage CB3 and outputs it to the gate of the MOS transistor M3 to turn on the MOS transistor M3, and bypasses charging current running through the cell C3.

With the above operations, when any one of the respective cell voltages VC1, VC2, and VC3 of the cell C1, the cell C2, and the cell C3 is higher than the cell mean voltage VCA (any of them is a VSS standard voltage), balancing of the intercell voltages is achieved by bypassing charging current running through the cell whose voltage goes high. This enables charging while balancing the cell voltages among the cell C1, the cell C2, and the cell C3.

### Modification of the Second Embodiment

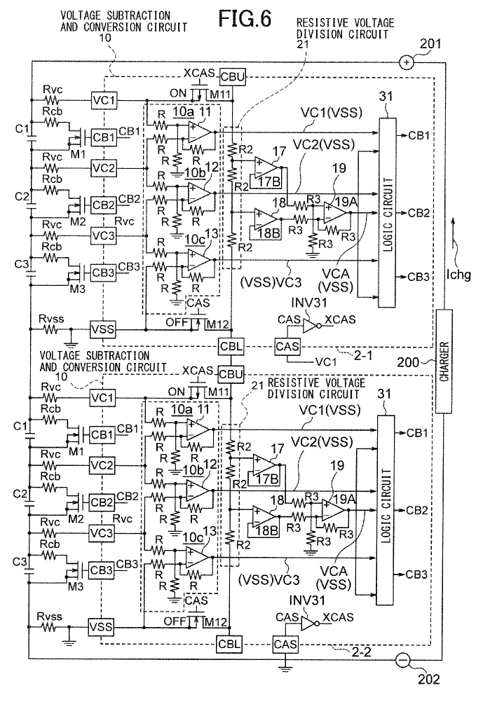

FIG. 6 is a circuit diagram showing a configuration of a charge control circuit according to a modification of the second embodiment and a peripheral circuit thereof. Two protection IC circuits of FIG. 4 are cascaded (vertically stacked) (hereinafter, symbols of the two protection IC circuits are 2-1, 2-2) to control charging of more than three cells. In comparison with the protection IC circuit 2 in FIG. 4, each of the protection IC circuits 2-1, 2-2 of FIG. 6 further includes:

(1) a buffer circuit 17B formed of a voltage follower circuit using an operational amplifier 17 configured to feed back an output voltage to an inverting terminal;
(2) a buffer circuit 18B formed of a voltage follower circuit using an operational amplifier 18 configured to feed back an output voltage to an inverting terminal;
(3) a voltage subtraction and conversion circuit 19A including four resistors R3 and an operational amplifier 19, and generating and outputting a cell mean voltage VCA(VSS), to be described below, by adding two input voltages and voltage converting into a ground potential VSS standard;
(4) a CAS terminal to be grounded, for example, when it is the lowest protection IC circuit, while the voltage VC1 (high level) is applied, for example, when it is the highest protection IC circuit;
(5) an inverter INV31 inverting a signal voltage of the CAS terminal to generate an XCAS signal;
(6) a MOS transistor M11, which does not connect the voltage VC1 to an upper side potential terminal of a resistive voltage division circuit 21 on the basis of a high level XCAS signal, while connecting the voltage VC1 to the upper potential terminal of the resistive voltage division circuit 21 on the basis of a low level XCAS signal; and
(7) a MOS transistor M12 which does not connect the voltage VSS to a lower potential terminal of the resistive voltage division circuit 21 when the CAS terminal is at high level, while connecting the voltage VSS to the lower potential terminal of the resistive voltage division circuit 21 when the CAS terminal is grounded at low level.

In FIG. 6, the CAS signal of the protection IC circuit 2-2 goes to low level by grounding the CAS terminal of the protection IC circuit 2-2, and the MOS transistor M11 is turned off. In addition, the XCAS signal becomes a high level signal, and the MOS transistor M12 is turned on. A VC1 level (high level) voltage is inputted into the CAS terminal of the protection IC circuit. With this, the CAS signal in the protection IC circuit 1-1 goes to high level, and the MOS transistor M11 is turned on. The XCAS signal goes to high level, and the MOS transistor M12 is turned off, With this, a voltage of the CBU terminal in the protection IC circuit 2-1 becomes voltage the voltage VC1, and the CBL terminal of the protection IC circuit 2-1 becomes the ground potential VSS. In addition, since the MOS transistor M12 of the protection IC circuit 2-1 is turned off, the VSS terminal and the CBL terminal of the protection IC circuit 2-1 are in an open state. Since the MOS transistor M11 of the protection IC circuit 2-2 is turned off, the terminal of the voltage VC1 and the CBU terminal of the protection IC circuit 2-2 enter an open state. Note that the CBL terminal of the protection IC circuit 2-1 and the CBU terminal of the protection IC circuit 2-2 are connected.

In the charge control circuit configured as described above, after dividing a voltage between the voltage VC1 of the cell C1 and the voltage VSS of the cell C3 with the three resistors R2, the resistive voltage division circuit 21, the buffer circuits 17B, 18B, and the voltage subtraction and conversion circuit 10A perform voltage buffering, subtraction and conversion into the ground potential VSS standard to generate a cell mean voltage VCA(VSS). For example, when balancing of cell voltages for six cells is achieved, the cell mean voltage VCA(VSS) is expressed by the following expression, wherein the VSS is the ground potential VSS of the protection IC circuit 2-2.

[Expression 2]

VCA(VSS)=(VC1−VSS)×(1R)/(6R)=(VC1−VSS)/6 (2)

Specifically, a value obtained by dividing a total voltage for the six cells by 6 is the cell mean voltage VCA (VSS). The buffer circuits 17B, 18B perform buffering of the respective voltage values. After computing a difference in two voltages from the respective buffering circuits 17B, 18B, the voltage subtraction and conversion circuit 19A performs the conversion into the ground potential VSS standard to generate the cell mean voltage VCA(VSS). With the above, the cell mean voltage VCA(VSS) can be accurately generated even when the protection IC circuits 2-1, 2-2 are cascaded. Furthermore, similar to the cases in FIG. 4 and FIG. 5, the logic circuit 31 compares the voltages VC1(VSS), VC2(VSS), and VC3(VSS) with the cell mean voltage VCA(VSS), generates predetermined cell balance period voltages CB2, CB2, and CB3, and turns on or off the MOS transistors M1, M2, and M3 on the basis of them, thereby achieving balancing of the respective cell voltages.

### Third Embodiment

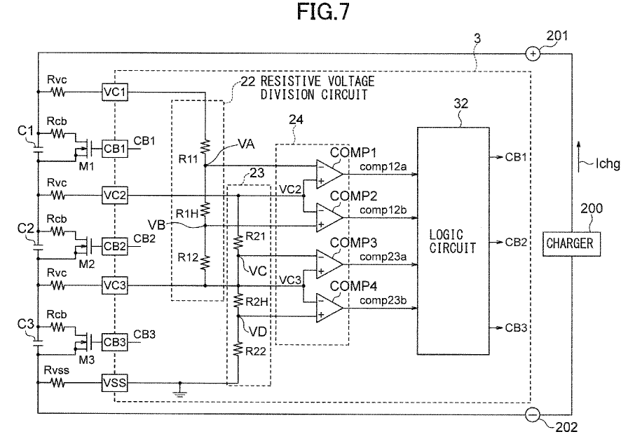

FIG. 7 is a circuit diagram showing a configuration of a charge control circuit according to a third embodiment and a peripheral circuit thereof. In comparison with the charge control circuit of FIG. 2, the charge control circuit of FIG. 7 is characterized in that it includes resistive voltage division circuits 22, 23, a comparator circuit 24, and a logic circuit 32, in place of the voltage subtraction and conversion circuit 10, the offset voltage addition circuit 20, and the logic circuit 30. In the following, the differences will be described.

In the resistive voltage division circuit 22, a resistor R11, a resistor R1H, and a resistor R11 are connected in series, wherein resistance values of the resistor R11 and the resistor R12 are set to a same value, and the resistor R1H is set to a resistance value ( 1/100, for example, to generate an offset voltage which is sufficiently smaller than a cell voltage) which is sufficiently smaller than the resistance value of the resistor R11 or the resistor R12. The resistive voltage division of the resistive voltage circuit 22 generates:

(1) a voltage VA obtained by adding a positive offset voltage to a mean voltage of the voltage VC1 of the cell C1 and the voltage VC2 of the cell C2; and
(2) a voltage VB obtained by adding a negative offset voltage to the mean voltage of the voltage VC1 of the cell C1 and the voltage VC2 of the cell C2.

In the resistive voltage division circuit 23, a resistor R21, a resistor R2H, and a resistor R21 are connected in series, wherein resistance values of the resistor R21 and the resistor R22 are set to a same value, and the resistor R2H is set to a resistance value ( 1/100, for example, to generate an offset voltage which is sufficiently smaller than a cell voltage) which is sufficiently smaller than the resistance value of the resistor R21 or the resistor R22. The resistive voltage division of the resistive voltage circuit 23 generates:

(a) a voltage VC obtained by adding a predetermined positive offset voltage to a mean voltage of the voltage VC2 of the cell C2 and the voltage VC3 of the cell C3; and
(b) a voltage VD obtained by adding a predetermined negative offset voltage to the mean voltage of the voltage VC2 of the cell VC2 and the voltage VC3 of the cell C3.

The voltages VA, VB, VC, VD generated as described above are expressed by the following expressions:

[Expression 3]

VA=(VC1−VC3)×(R1H+R12)/(R11+R1H+R12) (3)

[Expression 4]

VB=(VC1−VC3)×(R12)/(R11+R1H+R12) (4)

[Expression 5]

VC=(VC2−VSS)×(R22+R2H)/(R21+R2H+R22) (5)

[Expression 6]

VD=(VC2−VSS)×(R22)/(R21+R2H+R22) (6)

Next, when the comparator COMP1 of the comparator circuit 22 compares the voltage VC2 with the voltage VA, and the voltage VC2 is higher than the voltage VA, the comparator COMP1 outputs a high level comparison result signal comp 12a to the logic circuit 32. Here, the voltage VA is a voltage obtained by adding the predetermined positive offset voltage to the mean voltage of the voltage VC1 of the cell C1 and the voltage VC2 of the cell C2. Thus, if the voltage VC2 and the voltage VA are compared and the voltage VC2 is higher, it can be determined that the voltage VC2 of the cell C2 is higher than the voltage VC1 of the cell C1. When the comparator COMP2 compares the voltage VB with the voltage VC2 and the voltage VC2 is lower than the voltage VB, the comparator COMP2 outputs a high level comparison result signal comp12b to the logic circuit 32. Here, the voltage VB is a voltage obtained by adding the predetermined negative offset voltage to the mean voltage of the voltage VC1 of the cell C1 and the voltage VC2 of the cell C2. Thus, if the voltage VB and the voltage VC2 are compared and the voltage VC2 is lower, it can be determined that the voltage VC1 of the cell C1 is higher than the voltage VC2 of the cell C2. When the comparator COMP3 compares the voltage VC3 with the voltage VC and the voltage VC3 is higher than the voltage VC, the comparator COMP3 outputs a high level comparison result signal comp23a to the logic circuit 32. Here, the voltage VC is a voltage obtained by adding the predetermined positive offset voltage to the mean voltage of the voltage VC2 of the cell C2 and the voltage VC3 of the cell C3. Thus, if the voltage VC3 and the voltage VC are compared and the voltage VC3 is higher, it can be determined that the voltage VC3 of the cell C3 is higher than the voltage VC2 of the cell C2. When the comparator COMP4 compares the voltage VD with the voltage VC3 and the voltage VC3 is lower than the voltage VD, the comparator COMP4 outputs a high level comparison result signal comp23b to the logic circuit 32. Here, the voltage VD is a voltage obtained by adding the predetermined negative offset voltage to the mean voltage of the voltage VC2 of the cell C2 and the voltage VC3 of the cell C3. Thus, if the voltage VD and the voltage VC3 are compared and the voltage VC3 is lower, it can be determined that the voltage VC2 of the cell C2 is higher than the voltage VC3 of the cell C3.

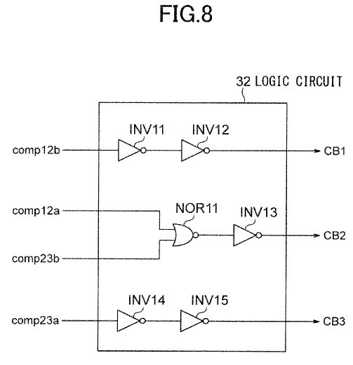

FIG. 8 is a circuit diagram showing a configuration of the logic circuit 32 of FIG. 7. The logic circuit 32 in FIG. 8 is configured to include one NOR gate NOR11 and five inverters INV11 to INV15. When the comparison result signal comp12b is at high level, the logic circuit 32 outputs the high level cell balance period voltage CB1 and turns on the MOS transistor M1 to bypass charging current of the cell C1. When the comparison result signal comp12a is at high level or when the comparison result signal comp23b is at high level, the logic circuit 32 outputs the high level cell balance period voltage CB2 and turns on the MOS transistor M2 to bypass charging current of the cell C2. Furthermore, when the comparison result signal comp23a is at high level, the logic circuit 32 outputs the high level cell balance period voltage CB3 and turns on the MOS transistor M3 to bypass charging current of the cell C3. With the above, charging is possible while balancing cell voltages among the cell C1, the cell C2, and the cell C3.

### Modification of the Third Embodiment

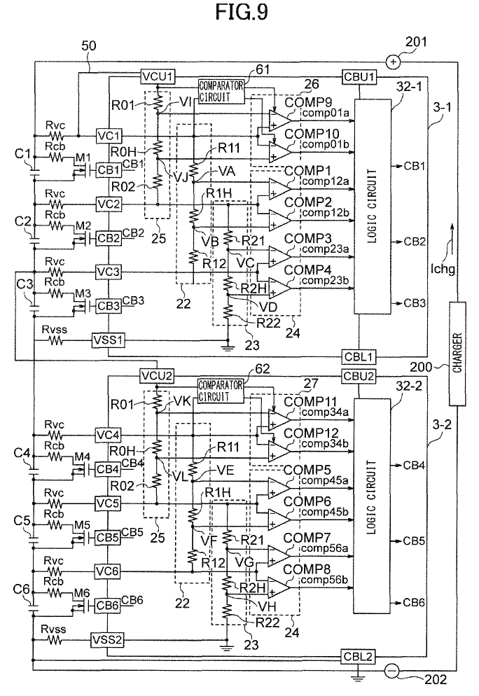

FIG. 9 is a circuit diagram showing a configuration of a charge control circuit according to a modification of the third embodiment and a peripheral circuit thereof. Specifically, FIG. 9 shows the case in which the two protection IC circuits of FIG. 7 (which are hereinafter assigned symbols 3-1, 3-2) are cascaded, wherein in comparison with the protection IC circuit 3 of FIG. 7,

(1) the protection IC circuit 3-1 has three resistors R01, R0H, R02 connected in series, and further includes a resistive voltage division circuit 25 which generates resistive voltage division voltages VI, VJ, a comparator circuit 26 having comparators COMP9, COMP10, a comparator circuit 61 which forcibly controls comparison result signals comp01a, comp01b of the comparators COMP9, COMP10 to low level when a potential difference between a voltage of a terminal VCU1 and voltage VC1 is 0.5V or less, and a connecting line 50 connecting the terminal VCU1 with the terminal of the voltage VC1,
(2) the protection IC circuit 3-2 has three resistors R01, R0H, R02 connected in series, and further includes the resistive voltage division circuit 25 which generates resistive voltage division voltages VK, VL, a comparator circuit 27 having comparators COMP11, COMP12, and a comparator 62 which forcibly controls comparison result signals comp34a, comp34b of the comparators COMP11, COMP12 to low level when a potential difference between a voltage of a terminal VCU2 and the voltage VC4 is 0.5V or less.

Here, in the protection IC circuit 3-2, in order to clearly describe a difference in operation from the protection IC circuit 3-1, the symbols have been changed as shown below. Specifically,

(1) output voltages of the resistive voltage division circuit 22 are VE, VF;
(2) output voltages of the resistive voltage division circuit 23 are VG, VH;
(3) comparators of the comparator circuit 24 are COMP5 to COMP8, and their comparison result signals are comp45a, comp45b, comp56a, comp56b;
(4) cell balance period voltages from the logic circuit 32-2 are CB4, CB5, CB6; and
(5) cell symbols are C4, C5, and C6.

In addition, a positive electrode of the cell C3 is connected to the terminal VCU2 of the protection IC circuit 3-2, the terminal CRL1 of the protection IC circuit 3-1 is connected to the terminal CBL2 of the protection IC circuit 3-2, and the terminal CBL2 of the protection IC circuit 3-2 is grounded. In addition, resistance values of the resistors R01, R0H, and R02 in the resistive voltage division circuits 25, 26 are set similar to the resistive voltage division circuits 22, 23. Note that the protection IC circuit 3-1 has the terminal VCU1 for upper level connection and the ground terminal VSS1, and the protection IC circuit 3-2 has the terminal VCU2 for upper level connection and the ground terminal VSS2.

Resistive voltage division of the resistive voltage division circuit 25 of the protection IC circuit 3-1 generates the voltage V1 obtained by adding the predetermined positive offset voltage to the mean voltage of the voltage VC1 of the cell C1 and the voltage VC2 of the cell C2, and the voltage VJ obtained by adding the predetermined negative offset voltage to the mean voltage of the voltage VC1 of the cell C1 and the voltage VC2 of the cell C2. In the protection IC circuit 3-1, the voltages VA to VD are generated similar to FIG. 7. Resistive voltage division of the resistive voltage division circuit 25 of the protection IC circuit 3-2 generates the voltage VK obtained by adding the predetermined positive offset voltage to the mean voltage of the voltage VC3 of the cell C3 and the voltage VC4 of the cell C4, and the voltage VL obtained by adding the predetermined negative offset voltage to the mean voltage of the voltage VC3 of the cell C3 and the voltage VC4 of the cell C4. In the protection IC circuit 3-2, the voltages VE to VH are generated similar to the voltages VA to VD in FIG. 7. Therefore, the voltages VA to VL are expressed by the following expressions:

[Expression 7]

VA=(VC1−VC3)×(R1H+R12)/(R11+R1H+R12) (7)

[Expression 8]

VB=(VC1−VC3)×(R12)/(R11+R1H+R12) (8)

[Expression 9]

VC=(VC2−VSS1)×(R22+R2H)/(R21+R2H+R22) (9)

[Expression 10]

VD=(VC2−VSS1)×(R22)/(R21+R2H+R22) (10)

[Expression 11]

VE=(VC4−VC6)×(R1H+R12)/(R11+R1H+R12) (11)

[Expression 12]

VF=(VC4−VC6)×(R12)/(R11+R1H+R12)

[Expression 13]

VG=(VC5−VSS2)×(R22+R2H)/(R21+R2H+R22) (13)

[Expression 14]

VH=(VC5−VSS2)×(R22)/(R21+R2H+R22) (14)

[Expression 15]

VI=(VCU1−VC2)×(R01+R0H)/(R01+R0H+R02) (15)

[Expression 16]

VJ=(VCU1−VC2)×(R01)/(R01+R0H+R02) (16)

[Expression 17]

VK=(VCU2−VC5)×(R01+R0H)/(R01+R0H+R02) (17)

[Expression 18]

VL=(VCU2−VC5)×(R01)/(R01+R0H+R02) (18)

The comparators COMP1 to COMP4 of the comparator circuit 24 in the protection IC circuit 3-1 respectively operate similarly to FIG. 7, and output the comparison result signals comp12a, comp12b, comp23a, comp23b to the logic circuit 32-1. In addition, the comparators COMP5 to COMP5 of the comparator circuit 24 in the protection IC circuit 3-2 respectively operate similarly to the comparators COMP1 to COMP2 in FIG. 7, and output the comparison result signals comp45a, comp45b, comp56a, comp56b to the logic circuit 32-1.

When the comparator COMP9 of the comparator circuit 26 compares the voltage VC1 with the voltage V1, and the voltage VC1 is higher than the voltage V1, the comparator COMP9 outputs a high level comparison result signal comp01a to the logic circuit 32-1. However, when a voltage difference between the voltage of the terminal VCU1 and the voltage VC1 is 0.5V or less, the comparator COMP9 forcibly sets the comparison result signal comp01a to low level. In FIG. 9, since VCU1=VC1, the comparison result signal comp01a is at low level. When the comparator COMP10 compares the voltage VJ with the voltage VC1 and the voltage VC1 is lower than the voltage V1, the comparator COMP10 outputs a high level comparison result signal comp01b to the logic circuit 32-1. However, when a voltage difference between the voltage of the terminal VCU1 and the voltage VC1 is 0.5V or less, the comparator COMP10 forcibly sets the comparison result signal comp01b to low level. In FIG. 9, since VCU1=VC1, the comparison result signal comp01b is at low level.

When the comparator COMP11 of the comparator circuit 27 compares the voltage VC4 with the voltage VK, and the voltage VC1 is higher than the voltage VK, the comparison result signal comp34a is at high level. The voltage VK is a voltage obtained by adding the predetermined positive offset voltage to the mean voltage of the voltage VC3 of the cell C3 and the voltage VC4 of the cell C4. Thus, if the voltage VC4 and the voltage VK are compared and the voltage VC4 is higher, it can be determined that the voltage VC4 of the cell C4 is higher than the voltage VC3 of the cell C3. When the comparator COMP12 compares the voltage VL with the voltage VC4, and the voltage VC1 is higher than the voltage VL, the comparison result signal comp34b is at high level. The voltage VL is a voltage obtained by adding the predetermined negative offset voltage to the mean voltage of the voltage VC5 of the cell C5 and the voltage VC6 of the cell C6. Thus, if the voltage VL and the voltage VC4 are compared and if the voltage VC4 is lower when the voltage VC1 is higher than the voltage VL, it can be determined that the voltage VC3 of the cell C3 is higher than the voltage VC4 of the cell C4.

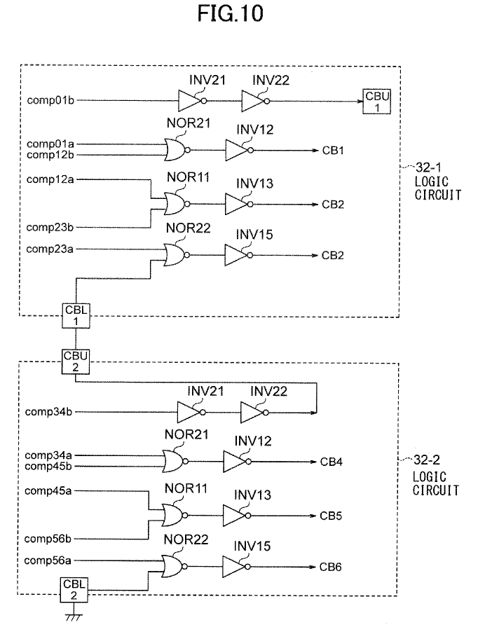

FIG. 10 is a circuit diagram showing configurations of the logic circuits 32-1, 3-2 of FIG. 9. The logic circuit 32-1 in FIG. 10 is configured to include three NOR gates NOR11, NOR21, and NOR22 and five inverters INV12, INV13, INV15, INV21, and INV22. The logic circuit 32-2 is configured to include three NOR gates NOR11, NOR21, and NOR22, and five inverters INV12, INV13, INV15, INV21, and INV22.

When the comparison result signal comp01a is at high level or when the comparison result signal comp 126 is at high level, the logic circuit 32-1 outputs the high level cell balance period voltage CB1, which turns on the MOS transistor M2 to bypass charging current of the cell C1. When the comparison result signal comp12a is at high level or when the comparison result signal comp23b is at high level, the logic circuit 32-1 outputs the high level cell balance period voltage CB2, which turns on the MOS transistor M2 to bypass charging current of the cell C2. When the comparison result signal comp23a is at high level or when the voltage of the terminal CRL1 (which is an output voltage of the inverter 22 of the logic circuit 32-2 and the comparison result signal 34b) is at high level, the logic circuit 32-1 outputs the high level cell balance period voltage CB3, which turns on the MOS transistor M3 to bypass charging current of the cell C3.

When the comparison result signal comp34a is at high level or when the comparison result signal comp45b is at high level, the logic circuit 32-2 outputs the high level cell balance period voltage CB4, which turns on the MOS transistor M4 to bypass charging current of the cell C4. When the comparison result signal comp45a is at high level or when the comparison result signal comp56b is at high level, the logic circuit 32-2 outputs the high level cell balance period voltage CB5, which turns on the MOS transistor M5 to bypass charging current of the cell C5. When the comparison result signal comp56a is at high level and the voltage of the terminal CBL2 (which is a ground potential in the embodiment) is at high level, the logic circuit 32-2 outputs the high level cell balance period voltage CB5, which turns on the MOS transistor M6 to bypass charging current of the cell C6.

With the above, charging is possible while balancing cell voltages among the cells C1 to C6.

As described above, with the charge control circuit according to the present invention and the battery device provided therewith, balancing of cell voltages is easier to achieve than the conventional technique, and charging of voltages of all cells close to full charge becomes easier. In addition, the charge control circuit and the battery device provided therewith can be configured with simple circuits and provided at low cost.

Although the modifications of the embodiments described above describe the case of six cells, the present invention is not limited to this, and cascading of two or more protection IC circuits enables charge control of eight or more cells. In addition, although the embodiments describe the case of three cells, the present invention is not limited to these embodiments, and a similar configuration is possible even in the case of two cells.

### INDUSTRIAL APPLICABILITY

As described above in detail, with the charge control circuit according to the present invention and the battery device provided therewith, balancing of cell voltages is easier to achieve than the conventional technique, and charging of voltages of all cells close to full charge becomes easier. In addition, the charge control circuit and the battery device provided therewith can be configured with simple circuits and provided at low cost.

Although the preferred embodiments of the present invention have been described, it should be understood that the present invention is not limited to these embodiments, various modifications and changes can be made to the embodiments.

What is claimed is:

1. A charge control circuit for controlling charging of a plurality of batteries included in a battery circuit and connected in series when the battery circuit is charged by a charger at both ends of the battery circuit, the charge control circuit comprising;
a plurality of switching elements respectively connected in parallel to the plurality of batteries; and
a charge control device for reducing charging current to the respective batteries, wherein
the charge control device comprises one of;
(A) a first control device which converts voltages of the respective batteries into a plurality of converted battery voltages based on a predetermined reference voltage as a reference on the basis of voltages at both ends of the respective batteries, generates an offset battery voltage obtained by adding a predetermined offset voltage to the plurality of converted battery voltages, compares each of the plurality of converted battery voltages with the offset battery voltage, and reduces charging current to the corresponding battery by turning on the switching element connected in parallel to the corresponding battery when the each converted battery voltage is higher than the offset voltage;
(B) a second control device which converts voltages of the respective batteries into a plurality of converted battery voltages based on a predetermined reference voltage as a reference on the basis of voltages at both ends of the respective batteries, generates a battery mean voltage of the respective battery voltages which is a mean voltage of the respective voltages based on the predetermined reference voltage as a reference, compares each of the plurality of converted battery voltages with the battery mean voltage, and reduces charging current to the corresponding battery by turning on the switching element connected in parallel to the corresponding battery when the each converted battery voltage is higher than the battery mean voltage; and
(C) a third control device which generates a pair of offset battery voltages obtained by adding and subtracting a predetermined offset voltage to/from a mean voltage of a pair of mutually adjacent batteries of the plurality of batteries on the basis of voltages at both ends of the respective batteries, compares the pair of offset battery voltages with the voltage of one battery of the pair of mutually adjacent batteries to thereby determine a battery with a higher battery voltage of the pair of batteries when the pair of offset battery voltages are higher than the voltage of the one battery of the pair of mutually adjacent batteries, and reduces charging current to the corresponding battery by turning on the switching element connected in parallel to the battery whose battery voltage is determined to be higher.

2. The charge control circuit according to claim 1 for controlling charging to the plurality of batteries by cascading a plurality of circuits each provided with the charge control device.

3. A battery device comprising:
a battery circuit including a plurality of batteries connected in series; and
the charge control circuit according to claim 1.
